(19) United States
(12) Patent Application Publication
(10) Pub. No.: US 2024/0187955 A1
(43) Pub. Date: Jun. 6, 2024

(54) METHODS AND APPARATUSES FOR HANDLING A CHO EXECUTION CONDITION IN A NTN ENVIRONMENT AND A RELATED MRO MECHANISM

(71) Applicant: Lenovo (Beijing) Limited, Beijing (CN)

(72) Inventors: Lianhai Wu, Beijing (CN); Min Xu, Beijing (CN); Jing Han, Beijing (CN); Ran Yue, Beijing (CN); Jie Shi, Beijing (CN)

(73) Assignee: Lenovo (Beijing) Limited, Beijing (CN)

(21) Appl. No.: 18/285,182

(22) PCT Filed: Apr. 1, 2021
(86) PCT No.: PCT/CN2021/085016

§ 371 Date: Sep. 29, 2023

(51) Int. Cl. H04W 36/36; H04W 36/32

(52) U.S. Cl. CPC H04W 36/362; H04W 36/32

(57) ABSTRACT

Embodiments of the present application relate to methods and apparatuses for handling a conditional handover (CHO) execution condition in a non terrestrial network (NTN) environment and a related mobility robustness optimization (MRO) mechanism in the NTN environment. According to an embodiment of the present application, a method which may be performed by a UE can include: receiving, from a network device (e.g., a base station), configuration information for a CHO candidate target cell and an execution condition for the CHO candidate target cell, the execution condition at least includes a location-based condition associated with a location of the UE: evaluating the location-based condition included in the execution condition: and performing a CHO procedure to the CHO candidate target cell, in response to the execution condition being fulfilled.

### TECHNICAL FIELD

Embodiments of the present application generally relate to wireless communication technology, especially to methods and apparatuses for handling a conditional handover (CHO) execution condition in a non terrestrial network (NTN) environment and a related mobility robustness optimization (MRO) mechanism in the NTN environment.

### BACKGROUND

A base station (BS) can have some cells (or areas) to provide communication service. When a user equipment (UE) moves from a serving cell of a source BS to a target cell of a target BS, a handover procedure is performed. When a radio link failure (RLF) or a handover (HO) failure occurs for a UE, the UE may perform a radio resource control (RRC) re-establishment procedure. The UE may access a cell by a successful RRC re-establishment procedure. The accessed network will request UE information including a RLF report of the UE, such that the network can optimize the mobility problem based on the UE information from the UE. Accordingly, the UE will transmit a failure report to the network.

A NTN environment refers to networks or segments of networks, which use a spaceborne vehicle or an airborne vehicle for transmission. For example, a spaceborne vehicle includes a satellite, which may be a Low Earth Orbiting (LEO) satellite, a Medium Earth Orbiting (MEO) satellite, a Geostationary Earth Orbiting (GEO) satellite as well as a Highly Elliptical Orbiting (HEO) satellite. An airborne vehicle includes a High Altitude Platform (HAP) encompassing Unmanned Aircraft Systems (UAS) which includes Lighter than Air UAS (LTA), and a Heavier than Air UAS (HTA).

3rd Generation Partnership Project (3GPP) 5G networks are expected to increase network throughput, coverage, and robustness and reduce latency and power consumption. With the development of 3GPP 5G networks, various aspects need to be studied and developed to perfect the 5G technology. When a UE needs to perform a CHO procedure from a serving cell of a source BS (e.g., a source satellite BS) to a candidate cell of a candidate BS (e.g., a target satellite BS), details regarding how to handle a CHO execution condition in a NTN environment and a related MRO mechanism in the NTN environment have not been discussed.

### SUMMARY

Some embodiments of the present application provide a method, which may be performed by a UE. The method includes: receiving, from a network device (e.g., a BS), configuration information for a CHO candidate target cell and an execution condition for the CHO candidate target cell, the execution condition at least includes a location-based condition associated with a location of the UE; evaluating the location-based condition included in the execution condition; and performing a CHO procedure to the CHO candidate target cell, in response to the execution condition being fulfilled.

Some embodiments of the present application provide a further method, which may be performed by a UE. The further method includes: receiving, from a network device (e.g., a BS), configuration information for a CHO candidate target cell and an execution condition for the CHO candidate target cell, the execution condition at least includes a location-based condition associated with a location of the UE; evaluating the execution condition; and declaring a radio link failure (RLF) before the execution condition being fulfilled.

Some embodiments of the present application provide an additional method, which may be performed by a UE. The additional method includes: receiving, from a network device (e.g., a BS), configuration information for a CHO candidate target cell and an execution condition for the CHO candidate target cell, the execution condition at least includes a location-based condition associated with a location of the UE; evaluating the execution condition; and receiving a handover command from a source cell before the execution condition being fulfilled.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement any of the above-mentioned methods performed by a UE.

Some embodiments of the present application also provide a UE. The UE includes a processor and a wireless transceiver coupled to the processor; and the processor is configured: to receive, via the wireless transceiver, configuration information for a CHO candidate target cell and an execution condition for the CHO candidate target cell from a BS, wherein the execution condition at least includes a location-based condition associated with a location of the UE; to evaluate the location-based condition included in the execution condition; and to perform a CHO procedure to the CHO candidate target cell, in response to the execution condition being fulfilled.

Some embodiments of the present application provide a method, which may be performed by a network device (e.g., a BS). The method includes: transmitting, to a UE, configuration information for a CHO candidate target cell and an execution condition for the CHO candidate target cell, the execution condition at least includes a location-based condition associated with a location of the UE; and receiving a configuration complete message from the UE.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the above-mentioned further method performed by a network device (e.g., a BS).

Some embodiments of the present application also provide a network device (e.g., a BS). The network device includes a processor; and a wireless transceiver coupled to the processor, and the processor is configured: to transmit, via the wireless transceiver, configuration information for a CHO candidate target cell to a UE and an execution condition for the CHO candidate target cell, wherein the execution condition at least includes a location-based condition associated with a location of UE; and to receive, via the wireless transceiver, a configuration complete message from the UE.

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application;

FIG. 2 illustrates an exemplary flowchart of an intra-AMF handover procedure in accordance with some embodiments of the present application;

FIG. 3 illustrates an exemplary flow chart of a method for receiving an execution condition for a CHO candidate target cell in accordance with some embodiments of the present application;

FIG. 4 illustrates an exemplary flow chart of a method for evaluating an execution condition for a CHO candidate target cell in accordance with some embodiments of the present application;

FIG. 5 illustrates a further exemplary flow chart of a method for evaluating an execution condition for a CHO candidate target cell in accordance with some embodiments of the present application;

FIG. 6 illustrates an exemplary flow chart of a method for transmitting an execution condition for a CHO candidate target cell in accordance with some embodiments of the present application;

FIG. 7 illustrates an exemplary block diagram of an apparatus according to some embodiments of the present application; and

FIG. 8 illustrates a block diagram of an exemplary apparatus 800 according to some embodiments of the present disclosure.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8 and so on. It is contemplated that along with developments of network architectures and new service scenarios, all embodiments in the present application are also applicable to similar technical problems; and moreover, the terminologies recited in the present application may change, which should not affect the principle of the present application.

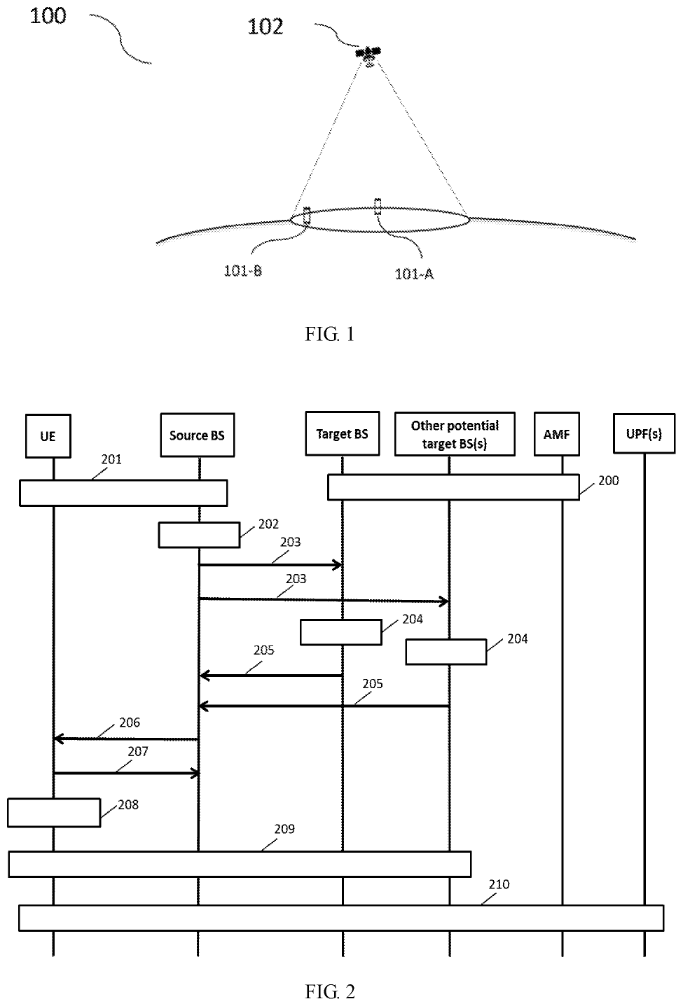

FIG. 1 illustrates a schematic diagram of a wireless communication system in accordance with some embodiments of the present application.

As shown in FIG. 1, the wireless communication system 100 includes two UEs, UE 101-A and UE 101-B, and a BS 102, for example, a satellite BS. Although merely one BS is illustrated in FIG. 1 for simplicity, it is contemplated that the wireless communication system 100 may include more BSs in some other embodiments of the present application. Similarly, although merely two UEs are illustrated in FIG. 1 for simplicity, it is contemplated that the wireless communication system 100 may include more UEs in some other embodiments of the present application. In the coverage of BS 102, UE 101-A is located at the nearest position to BS 102, that is, the distance between the position of UE 101-A and BS 102 is the smallest among all the positions in the coverage of BS 102, and UE 101-B is located at the farthest location to BS 102.

BS 102 may also be referred to as an access point, an access terminal, a base, a macro cell, a node-B, an enhanced node B (eNB), a gNB, a home node-B, a relay node, or a device, or described using other terminology used in the art. BS 102 is generally part of a radio access network that may include a controller communicably coupled to BS 102.

UE 101-A may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, UE 101-A may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, UE 101-A may include wearable devices, such as smart watches, fitness bands, optical head-mounted displays, or the like. Moreover, UE 101-A may be referred to as a subscriber unit, a mobile, a mobile station, a user, a terminal, a mobile terminal, a wireless terminal, a fixed terminal, a subscriber station, a user terminal, or a device, or described using other terminology used in the art.

The wireless communication system 100 is compatible with any type of network that is capable of sending and receiving wireless communication signals. For example, the wireless communication system 100 is compatible with a wireless communication network, a cellular telephone network, a time division multiple access (TDMA) based network, a code division multiple access (CDMA) based network, an orthogonal frequency division multiple access (OFDMA) based network, an LTE network, a 3GPP based network, a 3GPP 5G network, a satellite communications network, a high altitude platform network, and/or other communications networks.

FIG. 2 illustrates an exemplary flowchart of an intra-AMF handover procedure in accordance with some embodiments of the present application. The embodiments of FIG. 2 depict a CHO procedure where neither an access and mobility management function (AMF) nor user plane functions (UPFs) changes.

Referring to FIG. 2, in step 200, an AMF provides mobility control information. The UE context within a source BS contains information regarding roaming and access restrictions which were provided either at a connection establishment or at the last timing advance (TA) update procedure.

In step 201, the source BS transmits measurement configuration information to a UE, and the UE reports a measurement result to the source BS based on the measurement configuration information. In step 202, the source BS may decide to configure a CHO configuration, which is based on the measurement result reported by the UE.

In step 203, the source BS transmits a Handover REQUEST message for conditional handover to one or more candidate target BSs, e.g., a target BS and other potential target BS(s) as shown in FIG. 2. For example, the Handover REQUEST message for conditional handover may pass a transparent RRC container with necessary information to prepare a CHO procedure at a target BS side.

In step 204, the one or more candidate target BSs perform admission control, to decide whether to allow the CHO procedure of the UE after receiving the Handover REQUEST message for conditional handover from the source BS.

In step 205, based on an admission control result, the one or more candidate target BSs may prepare handover resource(s) for the UE and send a handover REQUEST ACKNOWLEDGE message including CHO configuration of candidate cell(s) to the source BS.

In step 206, the source BS sends an RRCReconfiguration message, which contains CHO configuration information of candidate cell(s) and CHO execution condition(s), to the UE. In step 207, the UE sends an RRCReconfigurationComplete message to the source BS.

In step 208, the UE maintains a connection with the source BS after receiving the CHO configuration information, and starts evaluating CHO execution condition(s) for the CHO candidate cell(s). If the corresponding CHO execution condition associated with at least one CHO candidate cell is satisfied, the UE detaches from the source BS, applies the stored corresponding configuration information for this CHO candidate cell, synchronizes to this CHO candidate cell, and completes the CHO handover procedure.

In step 209, the UE sends a CHO handover completion message to the one or more candidate target BSs. In step 210, a data forwarding path switch procedure between all entities in FIG. 2 needs to be further studied. Any ongoing data forwarding may be continued.

According to some agreements of 3GPP standard documents, an execution condition for a CHO procedure in a NTN environment may include the following:
Location-based execution condition: additional execution conditions based on a UE's location and a satellite's location can be considered in the NTN environment. Location based CHO procedure in LEO scenarios should consider deterministic satellite movement. For example, the location based execution condition may be expressed as a distance between the UE and the satellite.
Measurement-based execution condition: configuration of trigger thresholds and/or which measurement events to be used as an execution condition should consider the NTN environment, e.g., the small variation of the cell quality measured in a cell center and at a cell edge in the NTN environment.

As specified in 3GPP TS38.331, a measurement based execution condition includes two events, i.e., Event A3 and Event A5 as below. In an assumption that a source cell is a master cell group or secondary cell group (SpCell), 3GPP TS38.331 also defines entering conditions and leaving conditions of Event A3 and Event A5, respectively.
Event A3: a neighbour cell becomes offset better than a SpCell.
Event A5: a SpCell becomes worse than one threshold and a neighbour cell becomes better than another threshold.

As specified in 3GPP TS38.304, a cell selection criterion “S-criteria” is fulfilled when:
Srxlev>0 and Squal>0, wherein:

Srxlev=Qᵣₓₗₑᵥₘₑₐₛ−(Qᵣₓₗₑᵥₘᵢₙ+Q_{rxlevminoffset})−P_{compensation}−Qoffsetₜₑₘₚ; and

Squal=Q_{qualmeas}−(Q_{qualmin}+Q_{qualminoffset})−Qoffsetₜₑₘₚ, wherein:

| | |
|---|---|
| Srxlev | Cell selection RX level value (dB) |
| Squal | Cell selection quality value (dB) |
| Qoffsetₜₑₘₚ | Offset temporarily applied to a cell as specified in TS 38.331 [3] (dB) |
| Qᵣₓₗₑᵥₘₑₐₛ | Measured cell RX level value (RSRP) |
| Q_{qualmeas} | Measured cell quality value (RSRQ) |
| Qᵣₓₗₑᵥₘᵢₙ | Minimum required RX level in the cell (dBm). If the UE supports SUL |
| | frequency for this cell, Qᵣₓₗₑᵥₘᵢₙ is obtained from q-RxLevMinSUL, if |
| | present, in SIB1, SIB2 and SIB4, additionally, if Q_{rxlevminoffsetcellSUL} is |
| | present in SIB3 and SIB4 for the concerned cell, this cell specific offset is |
| | added to the corresponding Qrxlevmin to achieve the required minimum |
| | RX level in the concerned cell; |
| | else Qᵣₓₗₑᵥₘᵢₙ is obtained from q-RxLevMin in SIB1, SIB2 and SIB4, |
| | additionally, if Q_{rxlevminoffsetcell} is present in SIB3 and SIB4 for the |
| | concerned cell, this cell specific offset is added to the corresponding |
| | Qrxlevmin to achieve the required minimum RX level in the concerned |
| | cell. |
| Q_{qualmin} | Minimum required quality level in the cell (dB). Additionally, if |
| | Q_{qualminoffsetcell} is signalled for the concerned cell, this cell specific offset |
| | is added to achieve the required minimum quality level in the concerned |
| | cell. |
| Q_{rxlevminoffset} | Offset to the signalled Qᵣₓₗₑᵥₘᵢₙ taken into account in the Srxlev |
| | evaluation as a result of a periodic search for a higher priority PLMN |
| | while camped normally in a VPLMN, as specified in TS 23.122 [9]. |
| Q_{qualminoffset} | Offset to the signalled Q_{qualmin} taken into account in the Squal evaluation |
| | as a result of a periodic search for a higher priority PLMN while camped |
| | normally in a VPLMN, as specified in TS 23.122 [9]. |
| P_{compensation} | For FR1, if the UE supports the additionalPmax in the NR-NS-PmaxList, |
| | if present, in SIB1, SIB2 and SIB4: |
| | max (P_{EMAX1} − P_{PowerClass}, 0) − (min(P_{EMAX2}, P_{PowerClass}) − min(P_{EMAX1}, |
| | P_{PowerClass})) (dB); |
| | else: |
| | max(P_{EMAX1} − P_{PowerClass}, 0) (dB) |
| | For FR2, P_{compensation} is set to 0. |
| P_{EMAX1}, | Maximum TX power level of a UE may use when transmitting on the |
| P_{EMAX2} | uplink in the cell (dBm) defined as P_{EMAX} in TS 38.101 [15]. If UE |
| | supports SUL frequency for this cell, P_{EMAX1} and P_{EMAX2} are obtained |
| | from the p-Max for SUL in SIB1 and NR-NS-PmaxList for SUL |
| | respectively in SIB1, SIB2 and SIB4 as specified in TS 38.331 [3], else |
| | P_{EMAX1} and P_{EMAX2} are obtained from the p-Max and NR-NS-PmaxList |
| | respectively in SIB1, SIB2 and SIB4 for normal UL as specified in TS |
| | 38.331 [3]. |
| P_{PowerClass} | Maximum RF output power of the UE (dBm) according to the UE power |
| | class as defined in TS 38.101-1 [15]. |

According to some agreements of 3GPP standard documents, a MRO mechanism is for detecting connection failure(s) that occur due to Too Early or Too Late Handovers, or Handover to Wrong Cell. The general procedure is that after a RLF or a HO failure happens, a UE accesses a new cell by RRC re-establishment or connection setup. Once the UE enters a RRC connected state, the UE transmits a RLF report and a RACH report to the serving cell. The serving cell will transmit a failure indication including a RLF report to the last serving cell. Finally, the information is used to optimize the mobility.

Currently, details regarding how to handle a CHO execution condition in a NTN environment and a related MRO mechanism in the NTN environment have not been discussed. Some embodiments of the present application define a UE's behaviour(s) for starting or stopping an evaluation of a measurement-based execution condition in a case of a combined CHO execution condition. Some embodiments of the present application provide new CHO execution condition(s) in a NTN environment, which includes a location-based execution condition and S-criteria. Some embodiments of the present application introduce a MRO mechanism for a RLF in a case of a location-based execution condition combined with other CHO execution condition(s). Some embodiments of the present application introduce a MRO mechanism for a reception of a handover command in a case of a location-based execution condition combined with other CHO execution condition(s). More details will be illustrated in the following text in combination with the appended drawings.

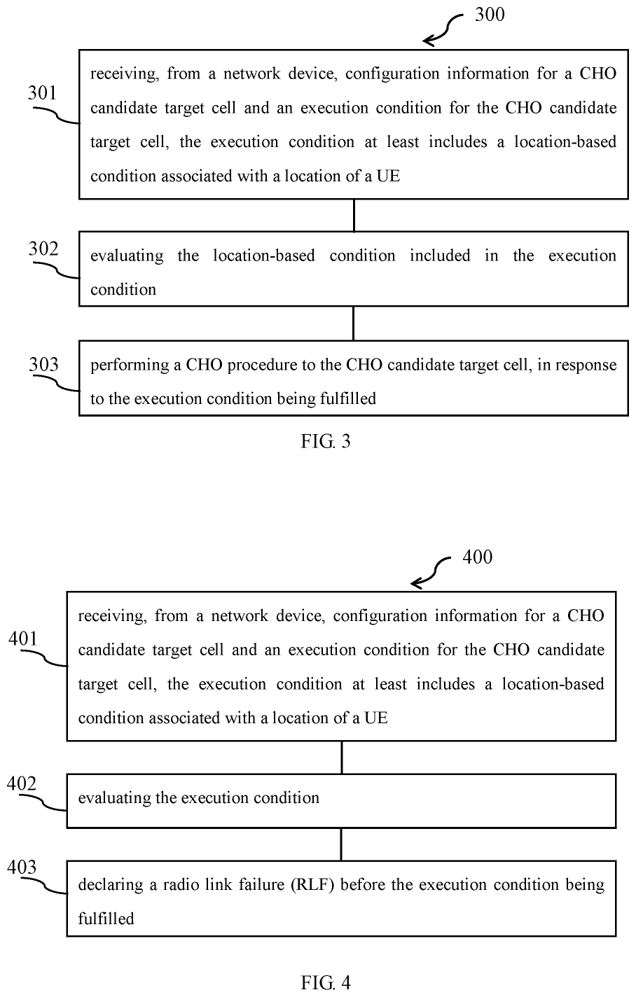

FIG. 3 illustrates an exemplary flow chart of a method for receiving an execution condition for a CHO candidate target cell in accordance with some embodiments of the present application. The embodiments of FIG. 3 may be performed by a UE (e.g., UE 101-A and UE 101-B illustrated and shown in FIG. 1). Although described with respect to a UE, it should be understood that other devices may be configured to perform a method similar to that of FIG. 3.

In the exemplary method 300 as shown in FIG. 3, in operation 301, a UE receives, from a BS (e.g., BS 102 illustrated and shown in FIG. 1), configuration information for a CHO candidate target cell and an execution condition for the CHO candidate target cell. The execution condition at least includes a location-based condition associated with a location of a UE. In some embodiments, the execution condition further includes a measurement-based condition.

According to some embodiments, the location-based condition is a location-based event which includes an entry condition and a leaving condition. In some embodiments, an entry condition of the location-based condition is: a distance between the UE and the CHO candidate target cell is an offset less than a first distance threshold; and/or a location of the UE is located at a configured area. In some embodiments, a leaving condition of the location-based condition is a distance between the UE and the CHO candidate target cell is an offset greater than a second distance threshold; and/or a location of the UE is not located at the configured area. Specific examples are described in Embodiments 1 and 2 as follows.

According to some embodiments, the measurement-based condition is at least one of:
(1) A measurement result of the CHO candidate target cell becomes an offset better than a measurement result of a source cell. For example, the source cell is a non terrestrial network (NTN) cell.
(2) A measurement result of the CHO candidate target cell becomes better than a measurement threshold.
(3) A measurement result of the source cell becomes worse than one measurement threshold, and a measurement result of the CHO candidate target cell becomes better than another measurement threshold.
(4) A measurement result of the CHO candidate target cell becomes an offset better than a measurement result of the source cell, the measurement result of the source cell becomes worse than one measurement threshold, and the measurement result of the CHO candidate target cell becomes better than another measurement threshold. Specific examples are described in Embodiments 1, 2, and 4 as follows.
(5) A cell selection criterion (e.g., “S-criteria” as specified in 3GPP TS38.304) for the CHO candidate target cell. In an embodiment, the cell selection criterion comprises whether a cell selection receiving level value of the CHO candidate target cell is greater than a first threshold (e.g., Srxlev>0); and whether a cell selection quality value of the CHO candidate target cell is greater than a second threshold (e.g., Squal>0). A specific example is described in Embodiment 3 as follows.

Referring back to FIG. 3, in operation 302, the UE evaluates the location-based condition included in the execution condition. In operation 303, the UE determines whether to perform a CHO procedure to the CHO candidate target cell.

According to some embodiments, if the location-based condition is fulfilled, the UE starts to evaluate the measurement-based condition. According to some other embodiments, if an entry condition of the location-based condition is considered as fulfilled, the UE starts to evaluate the measurement-based condition.

According to some embodiments, if the location-based condition is fulfilled and the measurement-based condition is also fulfilled, the UE initiates the CHO procedure to the CHO candidate target cell.

According to some embodiments, if a leaving condition of the location-based condition is fulfilled, the UE stops to evaluate the measurement-based condition. According to some other embodiments, if the UE determines that a location of the UE is not located at a configured area, the UE stops to evaluate the measurement-based condition. For example, the UE may determine whether the location of the UE is located at the configured area within a duration of a timer to trigger (TTT).

Details described in the embodiments as illustrated and shown in FIGS. 1, 2, and 4-8, especially, contents related to specific operations for handling a CHO execution condition, are applicable for the embodiments as illustrated and shown in FIG. 3. Moreover, details described in the embodiments of FIG. 3 are applicable for all the embodiments of FIGS. 1, 2, and 4-8.

FIG. 4 illustrates an exemplary flow chart of a method for evaluating an execution condition for a CHO candidate target cell in accordance with some embodiments of the present application. The embodiments of FIG. 4 may be performed by a UE (e.g., UE 101-A and UE 101-B illustrated and shown in FIG. 1). Although described with respect to a UE, it should be understood that other devices may be configured to perform a method similar to that of FIG. 4.

The same as the operation 301 in FIG. 3, in the exemplary method 400 as shown in FIG. 4, in operation 401, a UE receives, from a BS (e.g., BS 102 illustrated and shown in FIG. 1), configuration information for a CHO candidate target cell and an execution condition for the CHO candidate target cell. The execution condition at least includes a location-based condition associated with a location of a UE. In some embodiments, the execution condition further includes a measurement-based condition. The embodiments of FIG. 3 are applicable for the embodiments of FIG. 4.

In operation 402, the UE evaluates the execution condition for the CHO candidate target cell received in operation 401. In operation 403, the UE may declare a RLF before the execution condition being fulfilled.

According to some embodiments, in response to declaring the RLF, the UE further accesses the CHO candidate target cell and transmits assistant information to the CHO candidate target cell. In some embodiments, the assistant information transmitted by the UE comprises at least one of:
(1) an indication to indicate whether an entry condition of the location-based condition is fulfilled or not;
(2) an indication to indicate whether the entry condition of the location-based condition is fulfilled or not when declaring the RLF;
(3) time information regarding when the entry condition of the location-based condition is fulfilled, in response to fulfilling the entry condition of the location-based condition;
(4) an indication to indicate whether the measurement-based condition is fulfilled or not;
(5) an indication to indicate whether the measurement-based condition is fulfilled or not when declaring the RLF; and
(6) a time difference between first time information regarding when declaring the RLF and second time information regarding when the measurement-based condition is fulfilled, in response to fulfilling the measurement-based condition when declaring the RLF. A specific example is described in Embodiment 4 as follows.

Details described in the embodiments as illustrated and shown in FIGS. 1-3 and 5-8, especially, contents related to specific operations for handling a CHO execution condition, are applicable for the embodiments as illustrated and shown in FIG. 4. Moreover, details described in the embodiments of FIG. 4 are applicable for all the embodiments of FIGS. 1-3 and 5-8.

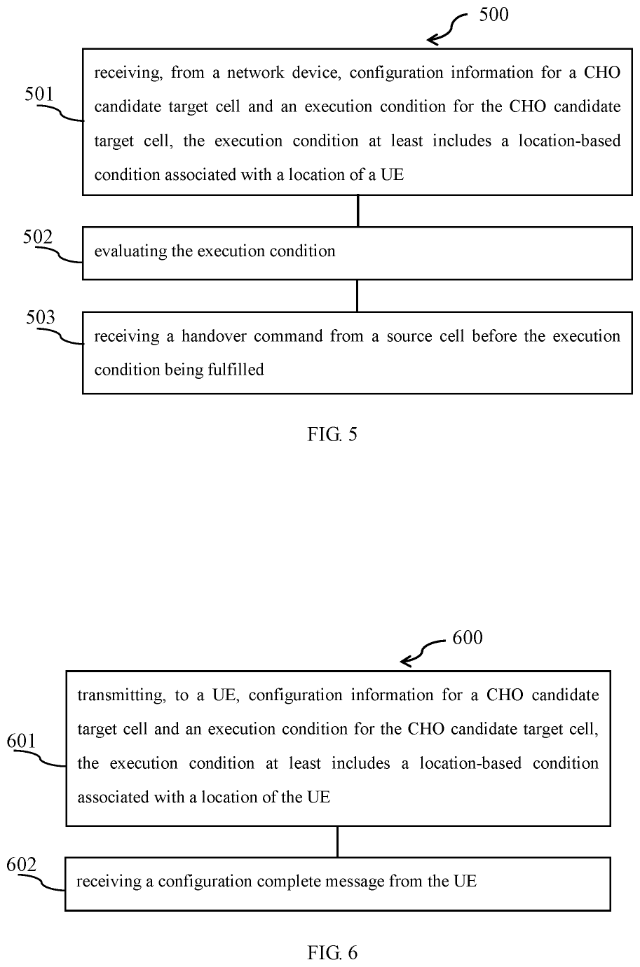

FIG. 5 illustrates a further exemplary flow chart of a method for evaluating an execution condition for a CHO candidate target cell in accordance with some embodiments of the present application. The embodiments of FIG. 5 may be performed by a UE (e.g., UE 101-A and UE 101-B illustrated and shown in FIG. 1). Although described with respect to a UE, it should be understood that other devices may be configured to perform a method similar to that of FIG. 5.

The same as the operation 301 in FIG. 3, in the exemplary method 400 as shown in FIG. 5, in operation 501, a UE receives, from a BS (e.g., BS 102 illustrated and shown in FIG. 1), configuration information for a CHO candidate target cell and an execution condition for the CHO candidate target cell. The execution condition at least includes a location-based condition associated with a location of a UE. In some embodiments, the execution condition further includes a measurement-based condition. The embodiments of FIG. 3 are applicable for the embodiments of FIG. 5.

In operation 502, the UE evaluates the execution condition for the CHO candidate target cell received in operation 501. In operation 503, the UE may receive a handover command from a source cell before the execution condition being fulfilled. For example, the source cell is a NTN cell.

According to some embodiments, in response to receiving the handover command from the source cell, the UE stores assistant information regarding whether the execution condition is fulfilled or not. According to some embodiments, in response to receiving the handover command from the source cell, the UE accesses a target cell and transmits the assistant information to the target cell. The target cell may be the CHO candidate target cell or another target cell different from the CHO candidate target cell. That is, the handover command may be associated with the CHO candidate target cell or another different target cell.

In some embodiments, the assistant information transmitted by the UE comprises at least one of:
(1) an indication to indicate whether an entry condition of the location-based condition is fulfilled or not;
(2) an indication to indicate whether the entry condition of the location-based condition is fulfilled or not when receiving the handover command;
(3) time information regarding when the entry condition of the location-based condition is fulfilled, in response to fulfilling the entry condition of the location-based condition;
(4) an indication to indicate whether the measurement-based condition is fulfilled or not;
(5) an indication to indicate whether the measurement-based condition is fulfilled or not when receiving the handover command; and
(6) a time difference between third time information regarding when receiving the handover command and fourth time information regarding when the measurement-based condition is fulfilled, in response to fulfilling the measurement-based condition when receiving the handover command. A specific example is described in Embodiment 5 as follows.

Details described in the embodiments as illustrated and shown in FIGS. 1-4 and 6-8, especially, contents related to specific operations for handling a CHO execution condition, are applicable for the embodiments as illustrated and shown in FIG. 5. Moreover, details described in the embodiments of FIG. 5 are applicable for all the embodiments of FIGS. 1-4 and 6-8.

FIG. 6 illustrates an exemplary flow chart of a method for transmitting an execution condition for a CHO candidate target cell in accordance with some embodiments of the present application. The embodiments of FIG. 6 may be performed by a network device, e.g., a BS or a source BS (e.g., BS 102 illustrated and shown in FIG. 1). Although described with respect to a BS, it should be understood that other devices may be configured to perform a method similar to that of FIG. 6.

In the exemplary method 600 as shown in FIG. 6, in operation 602, a network device (e.g., BS102 illustrated and shown in FIG. 1) transmits, to a UE (e.g., UE 101-A and UE 101-B illustrated and shown in FIG. 1), configuration information for a CHO candidate target cell and an execution condition for the CHO candidate target cell. The execution condition at least includes a location-based condition associated with a location of a UE. In some embodiments, the execution condition further includes a measurement-based condition. The location-based condition included in the execution condition is evaluated by the UE upon the UE receiving the execution condition. In operation 602, the network device receives a configuration complete message from the UE.

According to some embodiments, an entry condition of the location-based condition is: a distance between the UE and the CHO candidate target cell is an offset less than a first distance threshold; and/or a location of the UE is located at a configured area. According to some embodiments, a leaving condition of the location-based condition is: a distance between the UE and the CHO candidate target cell is an offset greater than a second distance threshold; and/or a location of the UE is not located at the configured area.

According to some embodiments, the measurement-based condition may be at least one of:
(1) A measurement result of the CHO candidate target cell becomes an offset better than a measurement result of a source cell. For example, the source cell is a NTN cell.
(2) A measurement result of the CHO candidate target cell becomes better than a measurement threshold.
(3) A measurement result of the source cell becomes worse than one measurement threshold, and a measurement result of the CHO candidate target cell becomes better than another measurement threshold.
(4) A measurement result of the CHO candidate target cell becomes an offset better than a measurement result of the source cell, the measurement result of the source cell becomes worse than one measurement threshold, and the measurement result of the CHO candidate target cell becomes better than another measurement threshold. Specific examples are described in Embodiments 1, 2, and 4 as follows.
(5) A cell selection criterion (e.g., “S-criteria” as specified in 3GPP TS38.304) for the CHO candidate target cell. In an embodiment, the cell selection criterion comprises whether a cell selection receiving level value of the CHO candidate target cell is greater than a first threshold (e.g., Srxlev>0); and whether a cell selection quality value of the CHO candidate target cell is greater than a second threshold (e.g., Squal>0). A specific example is described in Embodiment 3 as follows.

According to some embodiments, if the location-based condition is fulfilled, the measurement-based condition is started to be evaluated by the UE. According to some other embodiments, if an entry condition of the location-based condition is considered as fulfilled, the measurement-based condition is started to be evaluated by the UE.

According to some embodiments, a CHO procedure to the CHO candidate target cell is initiated by the UE, if the location-based condition is fulfilled and if the measurement-based condition is also fulfilled.

According to some embodiments, if a leaving condition of the location-based condition is fulfilled, an evaluation of the measurement-based condition is stopped by the UE. According to some other embodiments, if the UE determines that a location of the UE is not located at a configured area, an evaluation of the measurement-based condition is stopped by the UE.

According to some embodiments, in response to declaring a RLF, the network device receives, from the UE, assistant information regarding whether the execution condition is fulfilled. In some embodiments, the assistant information received by the network device comprises at least one of:
(1) an indication to indicate whether an entry condition of the location-based condition is fulfilled or not;
(2) an indication to indicate whether the entry condition of the location-based condition is fulfilled or not when declaring the RLF;
(3) time information regarding when the entry condition of the location-based condition is fulfilled, in response to fulfilling the entry condition of the location-based condition;
(4) an indication to indicate whether the measurement-based condition is fulfilled or not;
(5) an indication to indicate whether the measurement-based condition is fulfilled or not when declaring the RLF; and
(6) a time difference between time information regarding when declaring the RLF and further time information regarding when the measurement-based condition is fulfilled, if the measurement-based condition is fulfilled when declaring the RLF. A specific example is described in Embodiment 4 as follows.

According to some embodiments, before fulfilling the execution condition, the network device transmits a handover command associated with a target cell. The target cell may be the CHO candidate target cell or another target cell different from the CHO candidate target cell. That is, the handover command may be associated with the CHO candidate target cell or another different target cell.

According to some embodiments, after transmitting the handover command, the network device may receive, from the UE, assistant information regarding whether the execution condition is fulfilled. In some embodiments, the assistant information received by the network device comprises at least one of:
(1) an indication to indicate whether an entry condition of the location-based condition is fulfilled or not;
(2) an indication to indicate whether the entry condition of the location-based condition is fulfilled or not when receiving the handover command;
(3) time information regarding when the entry condition of the location-based condition is fulfilled, in response to fulfilling the entry condition of the location-based condition;
(4) an indication to indicate whether the measurement-based condition is fulfilled or not;
(5) an indication to indicate whether the measurement-based condition is fulfilled or not when receiving the handover command; and
(6) a time difference between time information regarding when receiving the handover command and further time information regarding when the measurement-based condition is fulfilled, if the measurement-based condition is fulfilled when receiving the handover command. A specific example is described in Embodiment 5 as follows.

Details described in the embodiments as illustrated and shown in FIGS. 1-5, 7, and 8, especially, contents related to specific operations for handling a CHO execution condition, are applicable for the embodiments as illustrated and shown in FIG. 6. Moreover, details described in the embodiments of FIG. 6 are applicable for all the embodiments of FIGS. 1-5, 7, and 8.

The following texts describe specific Embodiments 1-5 of the methods as shown and illustrated in FIGS. 3-6. According to Embodiments 1-5, a UE and a BS may perform following operations. The UE may be UE 101-A, UE 101-B, or the UE as shown and illustrated in FIGS. 1 and 2, respectively. The BS may be BS 102 as shown and illustrated in FIG. 1.

Embodiment 1: this embodiment refers to a scenario of how to handle an impact on an evaluation in a case of a location-based condition combined with other execution condition (e.g., a measurement-based condition) for a CHO candidate target cell and solves an issue of when to evaluate a measurement-based condition (e.g., CondEvent A3 and/or CondEvent A5) in combination with the location-based condition.
(1) Step 1: A UE accesses a network device (e.g., a source BS).
   The serving cell of the UE could be a NTN cell.
(2) Step 2: The UE receives configuration information for a CHO candidate target cell (e.g., candidate target cell #1) and an associated execution condition for the CHO candidate target cell.
   The associated execution condition may include a location-based condition and/or a measurement-based condition. The associated execution condition may be named as “a combined execution condition” or the like. For example, both a location-based condition and a measurement-based condition (e.g., CondEvent A3) are configured for candidate target cell #1.
   In different scenarios, a location-based condition may be different location based events including different entry conditions or leaving conditions. For instance, there may be three different ways describing entry conditions and leaving conditions of a location-based condition, i.e., Way #1, Way #2, or Way #3 as below.
      Way #1: In an example, a location-based condition is a location based event that a distance between the UE and a source primary cell (e.g., the serving cell of the UE) becomes an amount of offset greater than a neighbour cell (e.g., the CHO candidate target cell). For short, this location based event may be named as “Location based event A” or the like. Location based event A may include an entering condition and a leaving condition as follows:
         1) Entry condition: Dp−Hys>=Dn+offset1
         2) Leaving condition: Dp+Hys<Dn+offset1
         Dp (Distance primary) is a distance between the UE and the source primary cell (e.g., the serving cell of the UE).
         Dn (Distance neighbour) is a distance between the UE and the neighbour cell (e.g., the CHO candidate target cell).
         The offset1 is optional. The offset1 may be a parameter associated with a measurement object of the UE, a cell of the UE, and/or a satellite. The offset1 is cell specific.
         Hys is a hysteresis parameter for Location based event A.
      Way #2: In a further example, the location-based condition is a location based event that a distance between the UE and a neighbour cell (e.g., the CHO candidate target cell) becomes an offset less than a threshold. For short, this location based event may be named as “Location based event B” or the like. Location based event B may include an entering condition and a leaving condition as follows:
         1) Entry condition: Dn+offset2<threshold 1
         2) Leaving condition: Dn+offset3>threshold 2
         Dn (Distance neighbour) is distance between the UE and the neighbour cell (e.g., the CHO candidate target cell).
         Each of offset2 and offset3 may be a parameter associated with a measurement object of the UE, a cell of the UE, and/or a satellite. The offset2 and the offset3 are cell specific.
         Each of threshold 1 and threshold 2 may be a (pre-)configured distance threshold. The threshold 1 and threshold 2 may be the same or different.
      Way #3: In another example, the location-based condition is a location based event relating to an absolute area-based description (e.g., the UE is located at a (pre-)configured area). For short, this location based event may be named as “Location based event C” or the like. Location based event C may include an entering condition and a leaving condition as follows:
         1) Entry condition: the UE's location is located at a (pre-)configured area.
         2) Leaving condition: the UE's location is not located at the (pre-)configured area.
   The measurement-based condition could be one of: CondEvent A3, CondEvent A4, CondEvent A5, and “a combination of CondEvent A3 and CondEvent A5”.
      CondEvent A3: a measurement result of a conditional reconfiguration candidate cell (e.g., the CHO candidate target cell) becomes an amount of offset better than a primary cell (PCell) or a primary cell of a second cell group (PSCell) (e.g., the serving cell of the UE), as specified in 3GPP TS38.331.
      CondEvent A4: a measurement result of a neighbour cell (e.g., the CHO candidate target cell) becomes better than a measurement threshold, as specified in 3GPP TS38.331.
      CondEvent A5: a measurement result of a PCell or a PSCell (e.g., the serving cell of the UE) becomes worse than measurement absolute threshold 1, and a measurement result of a conditional reconfiguration candidate cell (e.g., the CHO candidate target cell) becomes better than measurement absolute threshold 2, as specified in 3GPP TS38.331.
(3) Step 3: When the location-based condition is met or when the location-based condition is considered as fulfilled, the UE starts to evaluate the measurement-based condition.
   When the UE receives the associated execution condition for the CHO candidate target cell, which includes a combination of a location-based condition and a measurement-based condition (e.g., a combination of CondEvent A3 and CondEvent A5), the UE will not evaluate the measurement-based condition immediately upon the reception of the associated execution condition. The UE firstly evaluate the location-based condition upon the reception of the associated execution condition, and after the location-based condition is met or considered as fulfilled, the UE starts to evaluate the measurement-based condition.
(4) Step 4: A CHO procedure can be triggered by the UE, if an entry condition of the location-based condition is fulfilled (or if the UE is located at the (pre-)configured area) and if the measurement-based condition is met within a duration of a timer to trigger (TTT).

Embodiment 2: this embodiment refers to a scenario of how to handle an impact on an evaluation in a case of a location-based condition combined with other condition(s) (e.g., CondEvent A3 and/or CondEvent A5) and solves an issue of when to stop evaluating a measurement-based condition in combination with the location-based condition.
(1) Step 1: A UE accesses a network device (e.g., a source BS).
   The serving cell of the UE could be a NTN cell.
(2) Step 2: The UE receives configuration information for a CHO candidate target cell (e.g., candidate target cell #1) and an associated execution condition for the CHO candidate target cell.
   The associated execution condition may include a location-based condition and a measurement-based condition. For example, both a location-based condition and a measurement-based condition (e.g., CondEvent A3 and/or CondEvent A5) are configured for candidate target cell #1.
   In different scenarios, a location-based condition may be different location based events including different entry conditions or leaving conditions. For instance, there may be three different ways describing entry conditions and leaving conditions of a location-based condition, i.e., Way #1, Way #2, or Way #3 as depicted in Embodiment 1 in the above.
   The measurement-based condition could be one of: CondEvent A3, CondEvent A4, CondEvent A5, and “a combination of CondEvent A3 and CondEvent A5”, as depicted in Embodiment 1 in the above.
(3) Step 3: When the location-based condition is met or when the location-based condition is considered as fulfilled, the UE starts to evaluate the measurement-based condition.
   When the UE receives the associated execution condition for the CHO candidate target cell, which includes a combination of the location-based condition and the measurement-based condition (e.g., CondEvent A3 and/or CondEvent A5), the UE will not evaluate the measurement-based condition immediately upon the reception of the associated execution condition. The UE firstly evaluate the location-based condition upon the reception of the associated execution condition, and after the location-based condition is met or considered as fulfilled, the UE starts to evaluate the measurement-based condition.
(4) Step 4: The UE stops evaluating the measurement-based condition for the CHO candidate target cell (e.g., candidate target cell #1), when a leaving condition of the location-based condition is fulfilled or when the UE is not located at the (pre-)configured area.

Embodiment 3: this embodiment introduces an execution condition for a CHO candidate target cell, which includes a location-based condition combined with a measurement-based condition (e.g., a cell selection criterion “S-criteria”).
(1) Step 1: A UE accesses a network device (e.g., a source BS).
   The serving cell of the UE could be a NTN cell.
(2) Step 2: The UE receives configuration information for a CHO candidate target cell (e.g., candidate target cell #1) and an associated execution condition for the CHO candidate target cell.
   The execution condition may include a location-based condition in combination with a measurement-based condition. For example, both a location-based condition and a measurement-based condition (e.g., a cell selection criterion “S-criteria” as specified in 3GPP TS38.304) are configured for candidate target cell #1.
(3) Step 3: The UE determines whether the UE is located at a (pre-)configured area, for example, within a time duration (e.g., a duration of a TTT).
(4) Step 4: The UE initiates a CHO procedure if the CHO candidate target cell (e.g., candidate target cell #1) can meet a cell selection criterion “S-criteria” and the UE is located at the (pre-)configured area. As specified in 3GPP TS38.304, a cell selection criterion “S-criteria” is fulfilled when: Srxlev>0 and Squal>0, wherein: Srxlev=Qᵣₓₗₑᵥₘₑₐₛ−(Qᵣₓₗₑᵥₘᵢₙ+Q_{rxlevminoffset})−P_{compensation}−Qoffsetₜₑₘₚ; and Squal=Q_{qualmeas}−(Q_{qualmin}+Q_{qualminoffset})−Qoffsetₜₑₘₚ, as described above.

Embodiment 4: this embodiment introduces a MRO mechanism for a RLF in a case of a location-based condition in combination with other CHO execution condition(s).
(1) Step 1: A UE accesses a network device (e.g., a source BS).
   The serving cell of the UE could be a NTN cell.
(2) Step 2: The UE receives configuration information for a CHO candidate target cell (e.g., candidate target cell #1) and an associated execution condition for the CHO candidate target cell.
   The execution condition may include a location-based condition and a measurement-based condition and may be named as “a combined execution condition” or the like. For example, both a location-based condition and a measurement-based condition (e.g., CondEvent A3) are configured for a candidate cell.
   The measurement-based condition could be one of: CondEvent A3, CondEvent A4, CondEvent A5, and “a combination of CondEvent A3 and CondEvent A5”, as depicted in Embodiment 1 in the above.
(3) Step 3: The UE evaluates the associated execution condition after receiving the configuration information for the CHO candidate target cell and the associated execution condition.
(4) Step 4: The UE declares a RLF. The UE may perform at least one of following operations:
   The UE stores a state whether the location-based condition is met or not when declaring the RLF.
   The UE stores the time when the location-based condition is met.
   The UE stores a time difference between the time when declaring the RLF and the time when the measurement-based condition is met.
(5) Step 5: The UE performs a RRC re-establishment procedure. Then, the UE transmits a RRCReconfigurationComplete message to a target BS after successfully completing the RRC re-establishment procedure, and the RRCReconfigurationComplete message includes an indication to indicate that assistant information is available. The assistant information is associated with the combined execution condition.
(6) Step 6: The target BS transmits a UEInformationRequest message to the UE after receiving the indication from the UE.
(7) Step 7: The UE transmits a UEinformationresponse message to the target BS. The following information is included in UE information response message.
   For example, in one case, the location-based condition combined with another measurement-based condition (e.g., CondEvent A3) is configured for target cell #1. A RLF occurs on a source cell. The UE needs to report a RLF-report for a SON purpose. In this case, a network needs to check whether the location-based condition combined with another measurement-based condition is suitable or not. The following information should be reported:
      Indication 1: an indication to indicate whether an entry condition of the location-based condition is met or not.
      Indication 2: an indication to indicate whether an entry condition of the location-based condition is met or not when declaring the RLF.
      Indication 3: time information regarding when an entry condition of the location-based condition is fulfilled, if the entry condition of the location-based condition has been fulfilled.
      Indication 4: an indication to indicate whether the measurement-based condition is fulfilled or not.
      Indication 5: an indication to indicate whether the measurement-based condition is fulfilled or not when declaring the RLF.
      Indication 6: if this measurement-based condition is met, the UE needs to further indicate what time the measurement-based condition is fulfilled (e.g., a time difference between time information regarding when declaring the RLF and further time information regarding when the measurement-based condition is fulfilled, if the measurement-based condition is fulfilled when declaring the RLF).
(8) Step 8: The target BS may transfer the information received from the UE to the source BS.

Embodiment 5: this embodiment introduces a MRO mechanism for receiving a handover command in the case of a location-based condition in combination with other condition(s).
(1) Step 1: A UE accesses a network device (e.g., a source BS).
The serving cell of the UE could be a NTN cell.
(2) Step 2: The UE receives configuration information for one CHO candidate target cell (e.g., candidate target cell #1) and an associated execution condition for the CHO candidate target cell.
   The execution condition may include a location-based condition and a measurement-based condition. For example, a location-based condition and a measurement-based condition (e.g., CondEvent A3) are configured for candidate target cell #1.
   The measurement-based condition could be one of CondEvent A3, CondEvent A4, CondEvent A5, and “CondEvent A3 and CondEvent A5”, as specified in 3GPP TS38.331.
(3) Step 3: The UE evaluates the execution condition after receiving configuration information for the CHO candidate target cell and an associated execution condition for the CHO candidate target cell.
(4) Step 4: The UE receives a handover command for a target cell (e.g., when the UE moves to a cell edge of candidate target cell #1 and candidate target cell #2 but the CHO condition is not met, the UE may receive a handover command for candidate target cell #1 or candidate target cell #2). After receiving the handover command, the UE may perform at least one of:
   The UE stores a state whether the location-based condition is met or not when the handover command is received.
   The UE stores the time when the location-based condition is met.
   The UE stores a time difference between time of receiving the handover command and time when the measurement-based condition is met.
(5) Step 5: The UE transmits a RRC message to a target BS after successfully completing the handover procedure, and the RRC message includes an indication to indicate that assistant information is available. The assistant information is associated with combined execution condition (e.g., a location-based condition combined with a measurement-based condition).
(6) Step 6: The target BS transmits a UEInformationRequest message to the UE after receiving the indication from the UE.
(7) Step 7: The UE transmits a UEInformationResponse message to the target BS. The following information may be included in the UEInformationResponse message:
   For example, in one case, the combined condition of the location-based condition and another measurement-based condition (e.g., CondEvent A3) is configured for target cell #1. The UE receives a handover command associated with target cell #1 or target cell #2. But the combined condition configured for target cell #1 is not met. The UE receives the handover command associated with target cell #1 or #2. The UE needs to report assistant information to the target cell for a SON purpose, because the condition for target cell #1 is met. In this case, the network needs to check whether the condition is suitable or not. The following information should be reported:
      Indication A: an indication to indicate whether an entry condition of the location-based condition is met or not.
      Indication B: an indication to indicate whether an entry condition of the location-based condition is met or not when the handover command is received.
      Indication C: time information regarding when an entry condition of the location-based condition is fulfilled, if the entry condition of the location-based condition has been fulfilled.
      Indication D: an indication to indicate whether the measurement-based condition is fulfilled or not.
      Indication E: an indication to indicate whether the measurement-based condition is fulfilled or not when receiving the handover command.
      Indication F: if this measurement-based condition is met, the UE needs to further indicate what time the measurement-based condition is fulfilled (e.g., a time difference between time information regarding when receiving the handover command and further time information regarding when the measurement-based condition is fulfilled, if the measurement-based condition is fulfilled when receiving the handover command).
(8) Step 8: The target BS may transfer the received information from the UE to the source BS.

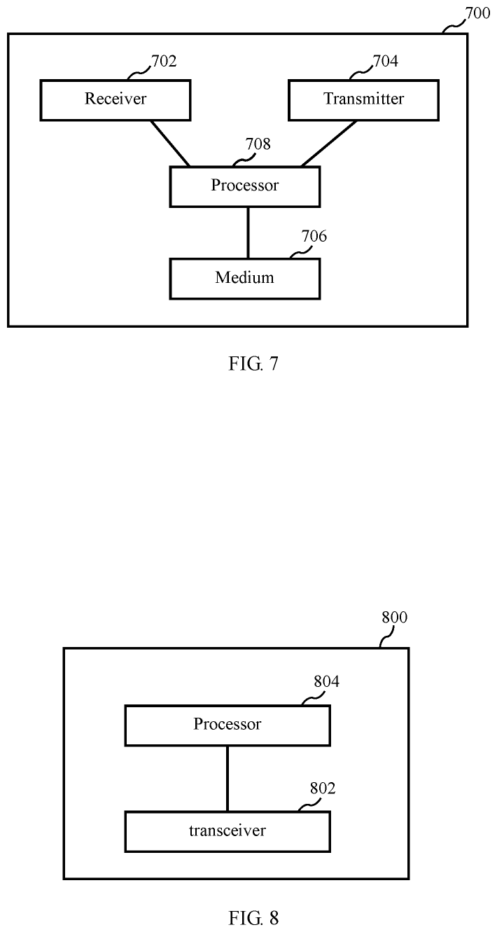

FIG. 7 illustrates an exemplary block diagram of an apparatus according to some embodiments of the present application. In some embodiments of the present application, the apparatus 700 may be a UE, which can at least perform the method illustrated in any of FIGS. 3-5. In some embodiments of the present application, the apparatus 700 may be a BS, which can at least perform the method illustrated in FIG. 6.

As shown in FIG. 7, the apparatus 700 may include at least one receiver 702, at least one transmitter 704, at least one non-transitory computer-readable medium 706, and at least one processor 708 coupled to the at least one receiver 702, the at least one transmitter 704, and the at least one non-transitory computer-readable medium 706.

Although in FIG. 7, elements such as the at least one receiver 702, the at least one transmitter 704, the at least one non-transitory computer-readable medium 706, and the at least one processor 708 are described in the singular, the plural is contemplated unless limitation to the singular is explicitly stated. In some embodiments of the present application, the at least one receiver 702 and the at least one transmitter 704 are combined into a single device, such as a transceiver. In certain embodiments of the present application, the apparatus 700 may further include an input device, a memory, and/or other components.

In some embodiments of the present application, the at least one non-transitory computer-readable medium 706 may have stored thereon computer-executable instructions which are programmed to implement the operations of the methods, e.g., as described in view of any of FIGS. 3-6, with the at least one receiver 702, the at least one transmitter 704, and the at least one processor 708.

Those having ordinary skills in the art would understand that the operations of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations of a method may reside as one or any combination or set of codes and/or instructions on a non-transitory computer-readable medium, which may be incorporated into a computer program product.

FIG. 8 illustrates a block diagram of an exemplary apparatus 800 according to some embodiments of the present disclosure. As shown in FIG. 8, the apparatus 800 may include at least one processor 804 and at least one transceiver 802 coupled to the processor 804. The apparatus 800 may be a network device (e.g., a BS) or a UE.

Although in this figure, elements such as the at least one transceiver 802 and processor 804 are described in the singular, the plural is contemplated unless a limitation to the singular is explicitly stated. In some embodiments of the present application, the transceiver 802 may be divided into two devices, such as a receiving circuitry and a transmitting circuitry. In some embodiments of the present application, the apparatus 800 may further include an input device, a memory, and/or other components.

In some embodiments of the present application, the apparatus 800 may be a UE. The transceiver 802 may be configured to receive, from a network device (e.g., a BS), configuration information for a CHO candidate target cell and an execution condition for the CHO candidate target cell from a BS, wherein the execution condition at least includes a location-based condition associated with a location of the UE. The processor 804 may be configured to evaluate the location-based condition included in the execution condition, and to perform a CHO procedure to the CHO candidate target cell in response to the execution condition being fulfilled.

In some embodiments of the present application, the apparatus 800 may be a network device (e.g., a BS). The transceiver 802 may be configured to transmit configuration information for a CHO candidate target cell to a UE and an execution condition for the CHO candidate target cell, wherein the execution condition at least includes a location-based condition associated with a location of UE. The transceiver 802 may be further configured to receive a configuration complete message from the UE.

In some embodiments of the present application, the apparatus 800 may further include at least one non-transitory computer-readable medium. In some embodiments of the present disclosure, the non-transitory computer-readable medium may have stored thereon computer-executable instructions to cause a processor to implement the method with respect to the UEs as described above. For example, the computer-executable instructions, when executed, cause the processor 804 interacting with transceiver 802, so as to perform operations of the methods, e.g., as described in view of any of FIGS. 3-6.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.”

1. A method performed by a user equipment (UE), the method comprising:
receiving configuration information for a conditional handover (CHO) candidate target cell and an execution condition for the CHO candidate target cell from a network device, the execution condition including at least a location-based condition associated with a location of the UE;
evaluating the location-based condition included in the execution condition; and
performing a CHO procedure to the CHO candidate target cell, in response to the execution condition being fulfilled.

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. A user equipment (UE), comprising:
at least one memory; and
at least one processor coupled with the at least one memory and configured to cause the UE to:
receive configuration information for a conditional handover (CHO) candidate target cell and an execution condition for the CHO candidate target cell from a network device, the execution condition including a location-based condition associated with a location of the UE;
evaluate the location-based condition included in the execution condition; and
perform a CHO procedure to the CHO candidate target cell, in response to the execution condition being fulfilled.

16. The UE of claim 15, wherein an entry condition of the location-based condition is at least one of:
a distance between the UE and the CHO candidate target cell is an offset less than a first distance threshold; and
the location of the UE is located at a configured area.

17. The UE of claim 15, wherein a leaving condition of the location-based condition is at least one of:
a distance between the UE and the CHO candidate target cell is an offset greater than a second distance threshold; and
the location of the UE is not located at a configured area.

18. The UE of claim 15, wherein the execution condition further includes a measurement-based condition, and wherein the measurement-based condition is at least one of:
a measurement result of the CHO candidate target cell becomes an offset better than a measurement result of a source cell;
the measurement result of the CHO candidate target cell becomes better than a first measurement threshold;
the measurement result of the source cell becomes worse than a second measurement threshold, and the measurement result of the CHO candidate target cell becomes better than a third measurement threshold;
the measurement result of the CHO candidate target cell becomes the offset better than the measurement result of the source cell, the measurement result of the source cell becomes worse than the second measurement threshold, and the measurement result of the CHO candidate target cell becomes better than the third measurement threshold; and
a cell selection criterion for the CHO candidate target cell.

19. The UE of claim 15, wherein the execution condition further includes a measurement-based condition, and the at least one processor is configured to cause the UE to:
start to evaluate the measurement-based condition, in response to one of:
fulfilling the location-based condition; and
an entry condition of the location-based condition being considered as fulfilled.

20. The UE of claim 15, wherein the execution condition further includes a measurement-based condition, and the at least one processor is configured to cause the UE to:
in response to fulfilling the location-based condition and in response to fulfilling the measurement-based condition, initiate the CHO procedure to the CHO candidate target cell.

21. The UE of claim 15, wherein the execution condition further includes a measurement-based condition, and the at least one processor is configured to cause the UE to:
stop to evaluate the measurement-based condition, in response to one of:
fulfilling a leaving condition of the location-based condition; and
determining that the location of the UE is not located at a configured area.

22. The UE of claim 21, wherein the at least one processor is configured to cause the UE to:
determine whether the location of the UE is located at the configured area within a duration of a timer to trigger (TTT).

23. The UE of claim 15, wherein the at least one processor is configured to cause the UE to:
declare a radio link failure (RLF) before the execution condition being fulfilled.

24. The UE of claim 23, wherein the at least one processor is configured to cause the UE to:
in response to declaring the RLF:
access the CHO candidate target cell; and
transmit assistant information to the CHO candidate target cell.

25. The UE of claim 24, wherein the assistant information comprises at least one of:
an indication to indicate whether an entry condition of the location-based condition is fulfilled or not;
an indication to indicate whether the entry condition of the location-based condition is fulfilled or not when declaring the RLF;
time information regarding when the entry condition of the location-based condition is fulfilled, in response to fulfilling the entry condition of the location-based condition;
an indication to indicate whether a measurement-based condition is fulfilled or not;
an indication to indicate whether the measurement-based condition is fulfilled or not when declaring the RLF; and
a time difference between first time information regarding when declaring the RLF and second time information regarding when the measurement-based condition is fulfilled, in response to fulfilling the measurement-based condition when declaring the RLF.

26. The UE of claim 15, wherein the at least one processor is configured to cause the UE to:
receive a handover command from a source cell before the execution condition being fulfilled.

27. The UE of claim 26, wherein the at least one processor is configured to cause the UE to:
in response to receiving the handover command from the source cell:
access a target cell; and
transmit assistant information to the target cell, and
wherein the target cell is one of:
the CHO candidate target cell; and
another target cell different from the CHO candidate target cell.

28. The UE of claim 27, wherein the assistant information comprises at least one of:
an indication to indicate whether an entry condition of the location-based condition is fulfilled or not;
an indication to indicate whether the entry condition of the location-based condition is fulfilled or not when receiving the handover command;
time information regarding when the entry condition of the location-based condition is fulfilled, in response to fulfilling the entry condition of the location-based condition;
an indication to indicate whether a measurement-based condition is fulfilled or not;
an indication to indicate whether the measurement-based condition is fulfilled or not when receiving the handover command; and
a time difference between third time information regarding when receiving the handover command and fourth time information regarding when the measurement-based condition is fulfilled, in response to fulfilling the measurement-based condition when receiving the handover command.

29. A processor for wireless communication, comprising:
at least one controller coupled with at least one memory and configured to cause the processor to:
receive configuration information for a conditional handover (CHO) candidate target cell and an execution condition for the CHO candidate target cell from a network device, the execution condition a location-based condition associated with a location of a user equipment (UE) that includes the processor;
evaluate the location-based condition included in the execution condition; and
perform a CHO procedure to the CHO candidate target cell, in response to the execution condition being fulfilled.

30. The processor of claim 29, wherein an entry condition of the location-based condition is at least one of:
a distance between the UE and the CHO candidate target cell is an offset less than a first distance threshold; and
the location of the UE is located at a configured area.

31. The processor of claim 29, wherein a leaving condition of the location-based condition is at least one of:
a distance between the UE and the CHO candidate target cell is an offset greater than a second distance threshold; and
the location of the UE is not located at a configured area.

32. The processor of claim 29, wherein the execution condition further includes a measurement-based condition, and wherein the measurement-based condition is at least one of:
a measurement result of the CHO candidate target cell becomes an offset better than a measurement result of a source cell;
the measurement result of the CHO candidate target cell becomes better than a first measurement threshold;
the measurement result of the source cell becomes worse than a second measurement threshold, and the measurement result of the CHO candidate target cell becomes better than a third measurement threshold;
the measurement result of the CHO candidate target cell becomes the offset better than the measurement result of the source cell, the measurement result of the source cell becomes worse than the second measurement threshold, and the measurement result of the CHO candidate target cell becomes better than the third measurement threshold; and
a cell selection criterion for the CHO candidate target cell.

33. A base station for wireless communication, comprising:
at least one memory; and
at least one processor coupled with the at least one memory and configured to cause the base station to:
transmit, to a user equipment (UE), configuration information for a conditional handover (CHO) candidate target cell and an execution condition for the CHO candidate target cell, the execution condition including at least a location-based condition associated with a location of the UE; and
receive, from the UE, a configuration complete message.
